(19) United States
(12) Patent Application Publication
(10) Pub. No.: US 2013/0091046 A1
(43) Pub. Date: Apr. 11, 2013

(54) Visualizing Performance Based on Trader Behavior

(71) Applicant: Hamid Benbrahim, Boston, MA (US)

(72) Inventor: Hamid Benbrahim, Boston, MA (US)

(21) Appl. No.: 13/325,209

(22) Filed: Dec. 14, 2011

Related U.S. Application Data
(60) Provisional application No. 61/545,652, filed on Oct. 11, 2011.

(51) Int. Cl. G06Q 40/04; G06Q 40/06

(52) U.S. Cl. 705/37

(57) ABSTRACT

A computer implemented techniques for visualize performance of a particular security or a portfolio of securities based on the behavior of traders that trade in the particular security or portfolio of securities is described.

This application claims priority under 35 U.S.C. §119 to U.S. Provisional Patent Application Ser. No. 61/545,652, filed Oct. 11, 2011, and entitled “Tool to Visualize Performance of a Security or Portfolio of Securities Based on Trader Behavior” the entire contents of which are hereby incorporated by reference.

### BACKGROUND

This invention relates generally to techniques for analyzing product trading characteristics.

Products or items such as financial instruments, e.g., securities, such as stocks, bonds, derivatives, and so forth are traded over trading venues such as markets and exchanges by various types of traders or by algorithms that cause trading based on various characteristics. As part of analysis of a position in such financial instruments it is generally desirable to access systemic risk and anticipate bubbles in pricing for an individual financial instrument or a portfolio of financial instruments.

### SUMMARY

Described are tools that allow analysts to visualize the performance of a particular security or a particular portfolio of securities, based on the behavior of traders that trade in the particular security or securities that comprise the particular portfolio. This type of visualization can assist analysts in accessing systemic risk and anticipate bubbles in pricing for the particular security or in underlying securities that comprise the particular portfolio and assess diversification with respect to trader types for a set of securities.

One or more aspects include a computer implemented method that includes mapping by one or more computers a time series F(d) of a security or a portfolio of securities to a specific distribution of trader types, simulating by one or more computers a market to generate a simulated time series M(d) of securities for each possible combination of trader types, computing by one or more computers a complexity distance between F(d) and every M(d), selecting by one or more computers the M(d) with the lowest distance and mapping by one or more computers the security time series F(d) to the point in a representation that is associated with the selected M(d).

The following are embodiments within the scope of the invention, the method includes acquiring a time series price(t), to be mapped (e.g. intraday prices, or daily prices) for a security. The method includes generating a time series of the absolute value of price changes d(t)=abs(price(t)−price(t−1)). The method includes generating an empirical distribution function of the time series F(d) which is the number of price changes that are less than d. The method includes normalizing the distribution to provide the values of d to lie between a range of values and the values of F(d) to lie between a range of values. Simulating a market includes producing simulated time series by selecting an initial price, sorting the simulated traders randomly, and causing each simulated trader to buy or sell according to the simulated trader's behavior. Random simulated traders use an unbiased random number generator to decide whether to buy or sell, value simulated traders buy if the price is below the value and sell if it is above the value and momentum simulated traders use a random number generator biased by the previous buys and sells. For each time simulating simulates a buy, the method increases the price by an increment and each time a sell the method decreases the price by the same increment.

Aspects also include analogous computer program products and apparatus.

The details of one or more embodiments of the invention are set forth in the accompanying drawings and the description below. Other features, objects, and advantages of the invention will be apparent from the description and drawings, and from the claims.

### DESCRIPTION OF DRAWINGS

The accompanied figures are to be used in conjunction with the description below.

FIG. 1 is a block diagram.

FIG. 1A is a pictorial representation of a web page having an embedded rendition for security according types of traders.

FIG. 2 is a flow chart depicting a high level functional view of a visualization tool.

FIG. 3 is a flow chart for producing an empirical distribution of a pricing time series.

FIG. 4 is a flow chart producing a distribution of a simulated pricing time series.

FIG. 5 is a flow chart depicting a mapping process.

FIG. 6 is a flow chart depicting simulated trading.

FIGS. 7 and 8 are diagrams depicting exemplary renditions for a security according to types of traders.

### DETAILED DESCRIPTION

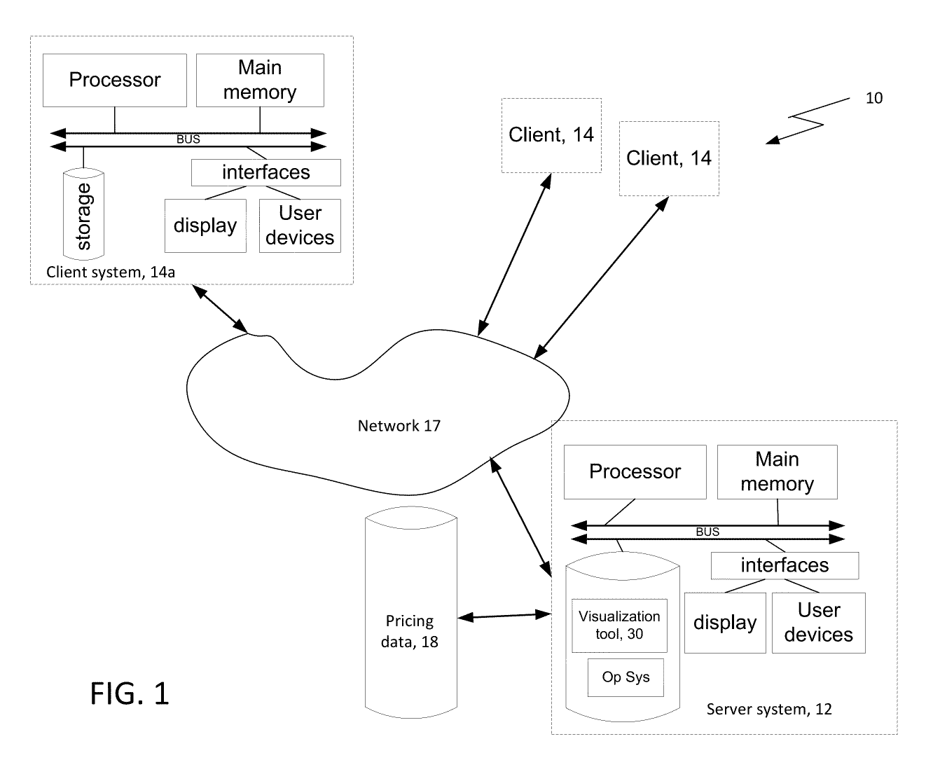

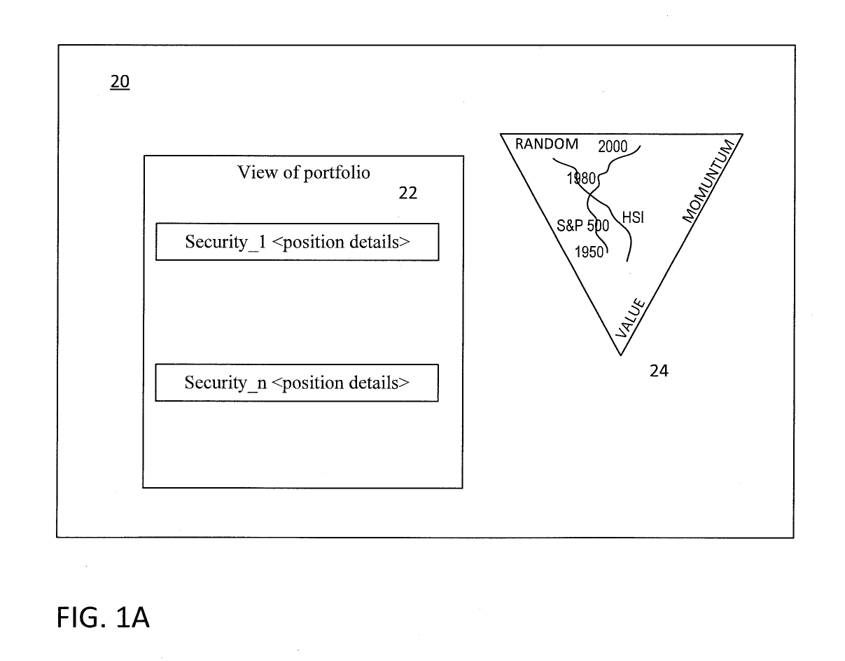

Referring now to FIG. 1, a networked system 10 includes a server computer system 12 executing a visualization tool that allows users to map time series of securities or indexes to a specific distribution of trader types. The mapping can be of stock securities, bonds, futures contracts, options, other derivative instruments, portfolios of such stock securities, bonds, futures contracts, options, other derivative instruments or indexes based on such stock securities, bonds, futures contracts, options, other derivative instruments, or other products, such as anything that is traded and has a trading history.

The computer system includes a processor, memory, storage user interfaces, display, bus, etc. (not specifically referenced). The server computer system 12 executes an operating system program and a visualization tool 30. The server computer system 12 accesses data from a database 18 (or other sources of data, such a pricing data and historical data).

The networked system 10 also includes one or more client systems generally 14 that are coupled to the server computer system 12, via a network 17. Client systems 14, such as client 14a, include processor, memory, storage user interfaces, display, bus, etc.

(not specifically referenced). In some embodiments the client systems 14 send portfolio information (e.g., one or more stock securities, bonds, futures contracts, options, other derivative instruments) to the server computer system 12 and the server computer system executes the visualization tool 30 and returns a representation of trader types (as will be discussed below).

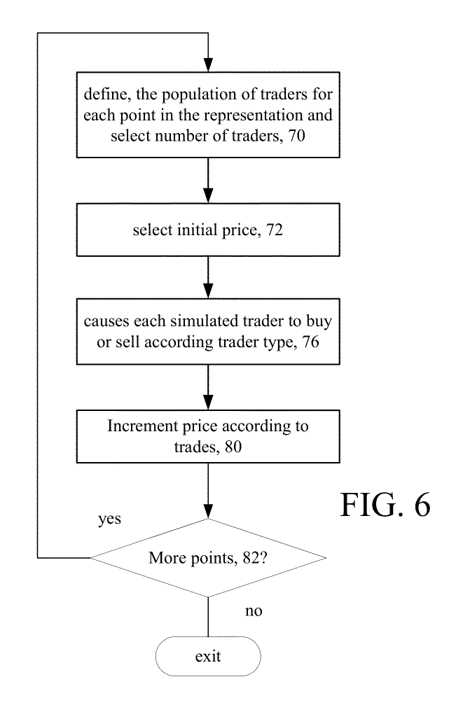

In some embodiments, the client systems 14 execute the visualization tool 30 and access data either from a remote source, e.g., 18 or a local source (not shown). In other embodiments, the client systems access the server computer 12 over the network 17, e.g., the Internet or other type of network such as a private network. The client systems 14 include a web browser, as pictorially represented by FIG. 1A, (or other type of user interface) and accesses the server computer system 12. The server 12 produces a web page 20 that is sent to the web browser on the client 14 and the web page 20 renders a representation 22 of a user's portfolio, having plural positions in, e.g., securities (security_{—}1 to security_n, illustrated) held at a brokerage firm or other financial services firm) and either automatically or on request generates a visual representation 24 of the trader types represented by the customer's portfolio (FIG. 6 type shown). Thus, the visualization tool can be a stand-alone application or a service that is made available free of charge or that is charged for.

The visualization tool 30 models trader types based on predefined trading behaviors. The modeling provides trader behavior as a time series of comparable complexity measures. Various trader types can be modeled. In an exemplary model, the trading behaviors modeled are “value” traders, “random” traders, and “momentum” traders. Traders can be persons or trading algorithms.

A value trader type is an investor or a trading algorithm that trades based on information that is considered “fundamentals.” For instance, value traders use information regarding pricing history of a security of a company in relation to the company's financial information, using value strategies, such as buying low P/E ratio stocks, low price-to-cash-flow ratio stocks, or low price-to-book ratio stocks.

A Random trader type is an investor or algorithm that trades based on no information in a random manner.

A Momentum trader type is an investor or an algorithm that imitates other traders. In momentum trading, traders or algorithms seek to find stocks that are trending in a particular direction (either an upward or downward trend (to short). Momentum traders typically use technical analysis to identify such stocks. Trends can be either short or medium or long term trends.

Although three trader types have be described for purposes of illustration of the concept, any number of trader types can be modeled by the visualization tool. One such trader type is an “obliged trader.” Obliged traders can be considered as traders that need to sell or buy based on prior obligations, such as traders that need to cover prior positions, e.g., short sell positions. Still other trader types include event traders, traders that trade based on an event as well as sentiment traders.

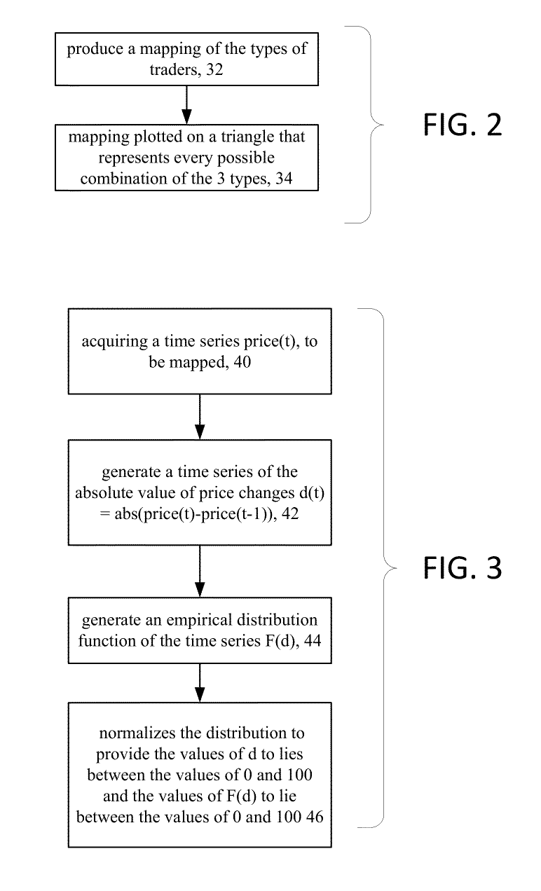

Referring now to FIG. 2, the visualization tool 30 maps 32 the types of traders involved in trading of the particular security or a set of securities of a portfolio. The map 32 is rendered 34 on a representation, such as in this case with three trader types, a triangle, as shown in FIGS. 5 and 6 that represent every possible combination of the three trader types. For modeling of fewer trader types, e.g., two trader types, a line would be used as the representation (with an indicium positioned on the line between endpoints of the line, with the endpoints representing 100% of one trader type and 0% of the other trader type) whereas for modeling of four trader types a square would be used, and so forth. In some implementations the visual representation can be a three dimensional representation. In other implementations rather than depicting the visualization, a set of values (e.g., a tuple) can be rendered.

Referring to FIG. 3, mapping 32 is performed by the visualization tool 30 by acquiring 40 a time series price (t), to be mapped at particular time intervals (e.g. intraday prices or daily prices) for a security (if the time series is modeling a daily basis). For other time intervals other time periods can be used, e.g., weekly, monthly, yearly, etc. From the time series the tool 30 generates 42 a time series of the absolute value of price changes d(t)=abs(price(t)−price(t−1)) for the particular time intervals. The tool 30 generates 44 an empirical distribution function of the time series F(d) which is the number of price changes that are less than d. The tool 30 normalizes 46 the distribution to provide the values of d to be between the values of a particular range, typical for convenience, a range of values between and including 0 and 100 can be used. The tool 30 also normalizes the values of F(d) to lie between a particular range, e.g., a range of values between and including 0 and 100.

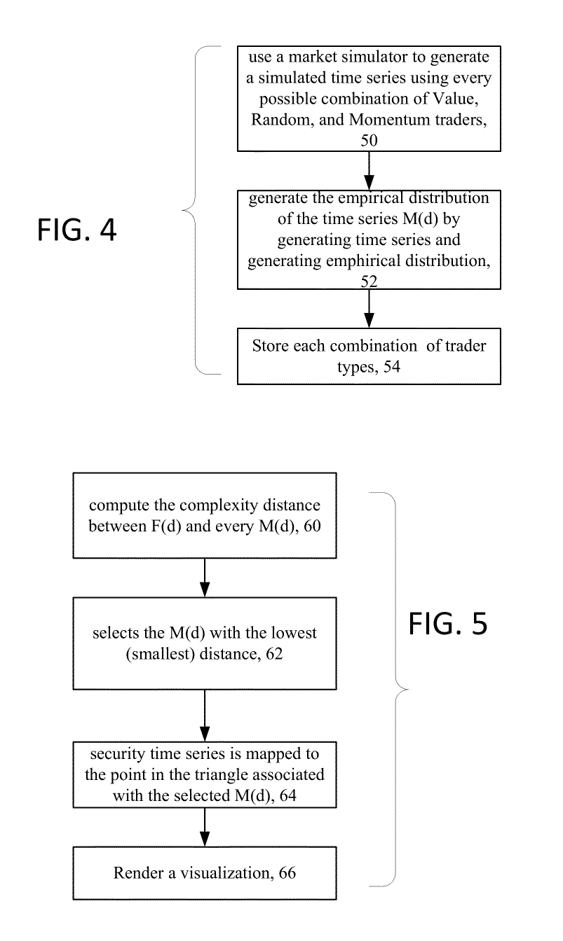

Referring now to FIG. 4, the visualization tool 30 uses a market simulator to generate 50 a simulated time series M(d) for every possible combination of Value, Random, and Momentum traders (e.g., for each percentage increment, where an increment is selectable by the user, typically 1%). The increment is based on the desired granularity/performance. For example, other increments can be used, e.g., 5%. The visualization tool 30 generates 52 the empirical distribution of the time series M(d) by generating a time series of the absolute value of price changes d(t)=abs(price(t)−price(t−1)) and by generating an empirical distribution function of the time series M(d) which is the number of price changes that are less than d, as discussed above. Each combination of Value, Random, and Momentum results in a particular M(d). That is, every point in the triangle will be mapped to one of the M(d)s. The resulting distributions are stored. That is, this action need only be executed only once and can be executed ahead of time where all resulting distributions are stored for future reference.

Referring now to FIG. 5, the visualization tool 30 computes 60 the complexity distance between F(d) and every M(d). The tool selects 62 the M(d) having the lowest (smallest) computed distance. The security time series is mapped 64 to the point in the triangle that is associated with the selected M(d). The complexity distance can be computed using a number of measures. For example one such measure is computing the Kolmogorov-Smirnov test distance (K-S for short). The K-S test distance is the largest deviation between the distribution functions F(d) and M(d). The visualization tool renders 66 an appropriate visualization.

Referring now to FIG. 6, the simulated time series are generated 50 using a market simulation that operates as follows: For each point in the triangle the market simulation defines 70 the population of traders; that is, the proportion of traders of each type. For this example, a proportion of 10% Value, 50% Random, and 40% Momentum is used to represent the corresponding point in the triangle. The larger the number of traders in each of the types, the more precise the model will be, whereas the longer the model will take to compute. The number of traders is configurable by the user. Any proportion of traders or number of traders can be used and all proportions and numbers are within the scope of this disclosure. An initial price is selected 72. The initial price can be any price value. For convenience, the price value in this example is $100. At each time step, the market simulator sorts 74 the simulated traders randomly, and causes 76 each simulated trader to buy or sell according to its trader type. Random traders use an unbiased random number generator to decide whether to buy or sell, which can be simulated using a coin flip. Value traders buy if the price is below $100 and sell if it is above $100. Momentum traders use a random number generator biased by the previous buys and sells. For instance, if there were 80 buys and 20 sells, then the random number generator will issue a buy 80% of the time and sell 20% of the time.

The visualization tool increments 78 (plus or minus) the price of the security according to the simulated trades conducted by each trader type. For each time the market simulator simulates a buy, the market simulator increases the price by an increment, e.g., $0.01 or other increment, and each time there is a sell the market simulator decreases the price by the same increment, e.g., $0.01 This increment can also be configured by the user to be any value. The process determines 82 if there are more points to process (e.g., intersections of percentages of each trader type) and otherwise exits. Percentages can be in any increment, such as 0.1% or 1% increments, but others can be used.

The corners of the triangle represent the three types. Each vertex of the triangle represents one of the trader types. If for instance a time series of a security maps to 33.3% Value, 33.3% Random, 33.3% Momentum, the time series will be placed at a point that is substantially at the center of the triangle. Whereas, if the time series maps to 100% Random, 0% Value, 0% Momentum, the representation of the time series will be placed at the “Random” corner vertex of the triangle and so forth. Any combination of portions of trader types can be represented.

For an obliged trader, the obliged trader can be modeled as a trader that performs two trades. For example, a short seller will sell the security and at some time later the short seller will be modeled to buy back the security. Other types of obliged traders are traders that cover margin, etc. In addition, models can be provided for sentiment traders that trade based on occurrences of events.

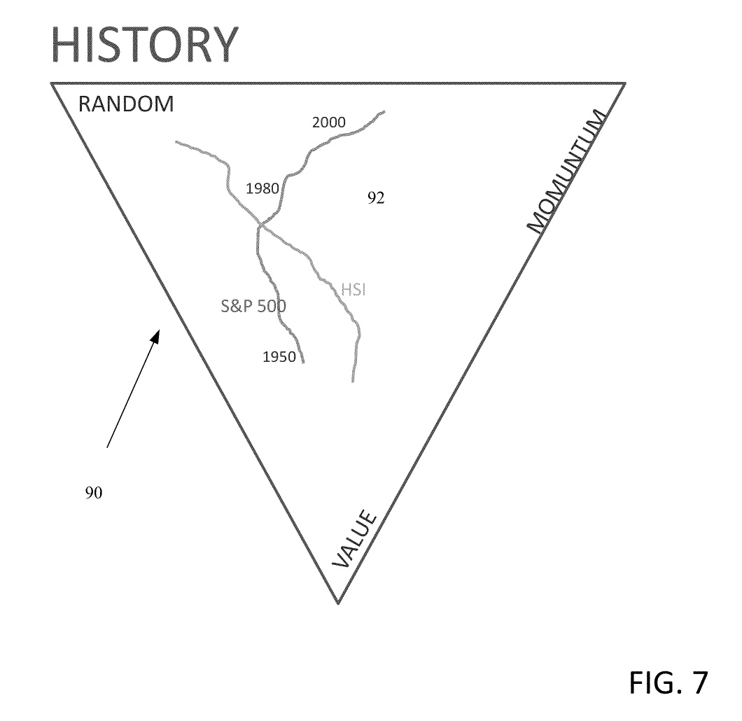

Referring now to FIG. 7, the visualization tool provides a mapping 90 to render in a visually informative manner a resulting a pricing history plotted based on the distribution of trader types. The pricing history, (plotted for each time increment, which can be any increment, e.g., a day, year, decade and so forth as mentioned above) is a point that represents percentages of the trader types. The points for each increment are plotted as a line graph 92 that has Value, Momentum and Random as the axes. The visualization tool produces the line graphs as depicted in FIG. 7 for HIS and the S&P 500. The S&P 500 is an example of (a particular portfolio of securities) e.g., the S&P 500 that uses the S&P 500 prices, and line for security HIS is an example of an individual security. The plots are depicted over a period of time, e.g., 1950 to 2000. As mentioned, any time period can be used. The price history is not intended as an actual prediction of an actual price of the security that is being simulated. Rather, the pricing history is used to generate statistics related to the security's pricing. Examples include distribution of returns and using information theory to compare these results.

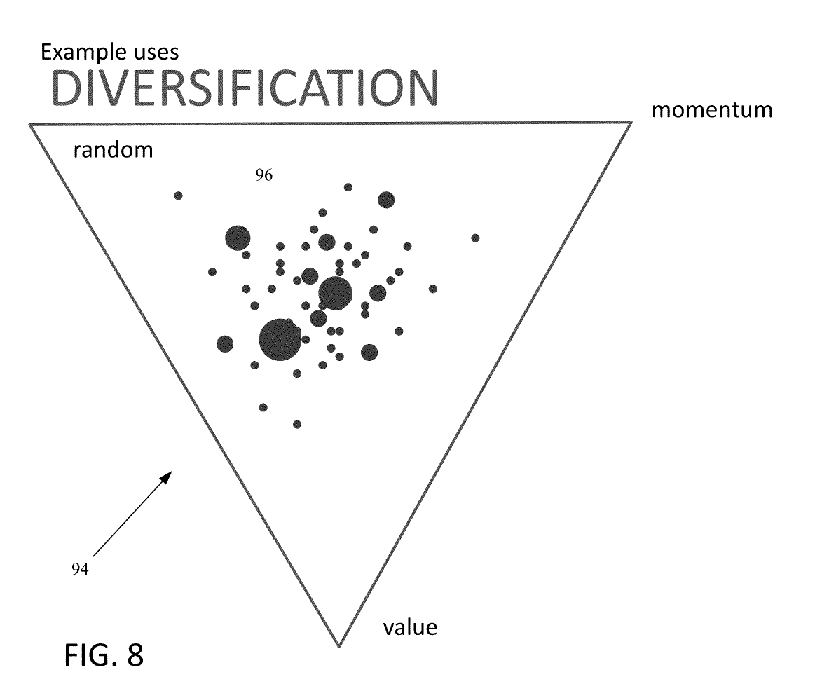

Referring to FIG. 8, another way 94 to represent the results is by indicia, such as the dots 96, at positions within the representation, e.g., triangle. The indicia representation approach can be used in several different manners. The indicia representation can be used with a portfolio of securities where each dot in the indicia representation corresponds to a security in the portfolio. Each dot can represent either the trader type composition for a single trading day or a time period of any duration for the trader type composition.

In some implementations the size of each dot can represent the amount invested in the individual security represented by the dot. In other implementations the dots are aggregations of individual securities showing “bunching” of securities with similar trader type characteristics. The positioning of the dots illustrates how the portfolio is skewed towards the different types of traders and can be used as a tool for re-balancing portfolio.

In some embodiments the indicia (dots) can be labeled and/or can be controls that when selected launches a window, etc. that depicts details of the particular security.

In either event, either using the representation of FIG. 7 or that of FIG. 8 or by presenting a tuple of values (Vᵥₐₗᵤₑ V_{random} Vₘₒₘₑₙₜᵤₘ), in an output, e.g., a table (Table 1, below) the results in the representation are rendered to the user on, e.g., a user display device and so forth. Other representation and statistics on a single security or on the composition of a portfolio of securities can be determined.

TABLE 1

| Instrument | Vᵥₐₗᵤₑ | V_{random} | Vₘₒₘₑₙₜᵤₘ | * * * |
|---|---|---|---|---|
| Security_1 | Vv1 | Vr1 | Vm1 | * * * |
| Security_2 | Vv2 | Vr2 | Vm2 | * * * |
| * * * | * * * | * * * | * * * | * * * |
| Security_n | Vvn | Vrn | Vmn | * * * |

A block diagram of components of the system was shown above in FIG. 1. User devices can be any sort of computing device capable of taking input from a user and communicating over a network (not shown) with server and/or with other client devices. For example, user device can be a mobile device, a desktop computer, a laptop, a cell phone, a personal digital assistant (“PDA”), a server, an embedded computing system, a mobile device, and so forth. User devices include monitor which render visual representations.

Server can be any of a variety of computing devices capable of receiving information, such as a server, a distributed computing system, a desktop computer, a laptop, a rack-mounted server, and so forth. Server may be a single server or a group of servers that are at a same location or at different locations.

Server can receive information from client device user device via interfaces. Interfaces can be any type of interface capable of receiving information over a network, such as an Ethernet interface, a wireless networking interface, a fiber-optic networking interface, a modem, and so forth. Server also includes a processor and memory. A bus system including, for example, a data bus and a motherboard, can be used to establish and to control data communication between the components of server.

Processor may include one or more microprocessors. Generally, processor may include any appropriate processor and/or logic that is capable of receiving and storing data, and of communicating over a network (not shown). Memory can include a hard drive and a random access memory storage device, such as a dynamic random access memory, machine-readable media, or other types of non-transitory machine-readable storage devices.

Components also include storage device, which is configured to store information, map, map templates, rules data for the rules, software for the rules engine, etc.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, while three trader types are modeled other models may include two trader types or more than three trader types and in those different representations would be used, such as a line or a square. Further, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer implemented method comprises:
mapping by one or more computers a time series F(d) of a security or a portfolio of securities to a specific distribution of trader types;
simulating by one or more computers a market to generate a simulated time series M(d) of securities for each possible combination of trader types;
computing by one or more computers a complexity distance between F(d) and every M(d);
selecting by one or more computers the M(d) with the lowest distance; and
mapping by one or more computers the security time series F(d) to the point in a representation that is associated with the selected M(d).

2. The method of claim 1 further comprising:
acquiring a time series price(t), to be mapped (e.g. intraday prices, or daily prices) for a security.

3. The method of claim 2 further comprising:
generating a time series of the absolute value of price changes d(t)=abs(price(t)−price(t−1)).

4. The method of claim 3 further comprising:
generating an empirical distribution function of the time series F(d) which is the number of price changes that are less than d.

5. The method of claim 4 further comprising:
normalizing the distribution to provide the values of d to lie between a range of values and the values of F(d) to lie between a range of values.

6. The method of claim 1 wherein simulating a market further comprises:
producing simulated time series by:
selecting an initial price;
sorting the simulated traders randomly, and
causing each simulated trader to buy or sell according to the simulated trader's behavior.

7. The method of claim 6, wherein random simulated traders use an unbiased random number generator to decide whether to buy or sell, value simulated traders buy if the price is below the value and sell if it is above the value and momentum simulated traders use a random number generator biased by the previous buys and sells.

8. The method of claim 6, wherein for each time simulating simulates a buy, the method increases the price by an increment and each time a sell the method decreases the price by the same increment.

9. The method of claim 1 further comprising:
causing a device to render a representation of the distribution of trader types associated with the security.

10. The method of claim 1 further comprising:
causing a device to render a visual representation of the mapping where the visual representation is a plot of a distribution of trader types as indices of the visual representation.

11. The method of claim 1 further comprising:
causing a device to render a visual representation of the mapping where the visual representation is an indicia that represents a set of trader types as indices of the visual representation.

12. The method of claim 11 wherein the indicia represents an individual security.

13. The method of claim 1 wherein the mapping is of a portfolio that comprises plural securities, the method further comprising:
causing a device to render a visual representation of the mapping for the plural securities where the visual representation comprises indicia plotted by trader type, and each indicia representing an individual security and the size of the indicia in the representation corresponding to an aggregate amount of a value that the security represented by the dot has in the portfolio.

14. The method of claim 1 wherein the mapping is of a portfolio that comprises plural securities, the method further comprising:
causing a device to render a visual representation of the mapping for the plural securities where the visual representation comprises indicia plotted by trader type, and size of indicia representing an aggregate of securities in the portfolio according to trader types of securities.

15. A computer program product tangibly stored on a computer readable storage device, the computer program product including instructions to cause a processor to:
map a time series F(d) of a security or a portfolio of securities to a specific distribution of trader types;
simulate a market to generate a simulated time series M(d) of securities for each possible combination of trader types;
compute a complexity distance between F(d) and every M(d);
select the M(d) with the lowest distance; and
map the security time series F(d) to the point in a representation that is associated with the selected M(d).

16. The computer program product of claim 15 further comprising instructions to:
acquire a time series price(t), to be mapped (e.g. intraday prices, or daily prices) for a security.

17. The computer program product of claim 16 further comprising instructions to:
generate a time series of the absolute value of price changes d(t)=abs(price(t)−price(t−1)).

18. The computer program product of claim 15 further comprising instructions to:
generate an empirical distribution function of the time series F(d) which is the number of price changes that are less than d.

19. The computer program product of claim 18 further comprising instructions to:
normalize the distribution to provide the values of d to lie between a range of values and the values of F(d) to lie between a range of values.

20. The computer program product of claim 15 further comprising instructions to:
produce a simulated time series by:
select an initial price;
sort the simulated traders randomly, and
cause each simulated trader to buy or sell according to the simulated trader's behavior.

21. The computer program product of claim 20 wherein random simulated traders use an unbiased random number generator to decide whether to buy or sell, value simulated traders buy if the price is below the value and sell if it is above the value and momentum simulated traders use a random number generator biased by the previous buys and sells.

22. The computer program product of claim 21 wherein for each simulated buy, the program increases the price by an increment and each time a sell the program decreases the price by the same increment.

23. The computer program product of claim 15 further comprising instructions to:
cause a device to render a representation of the distribution of trader types associated with the security.

24. The computer program product of claim 15 further comprising instructions to:
cause a device to render a visual representation of the mapping where the visual representation is a plot of a distribution of trader types as indices of the visual representation.

25. The computer program product of claim 15 further comprising instructions to:
cause a device to render a visual representation of the mapping where the visual representation is an indicia that represents a set of trader types as indices of the visual representation.

26. The computer program product of claim 15 wherein the indicia represents an individual security.

27. The computer program product of claim 15 wherein the mapping is of a portfolio that comprises plural securities, the computer program product further comprising instructions to:
cause a device to render a visual representation of the mapping for the plural securities where the visual representation comprises indicia plotted by trader type, and each indicia representing an individual security and the size of the indicia in the representation corresponding to an aggregate amount of a value that the security represented by the dot has in the portfolio.

28. The computer program product of claim 15 wherein the mapping is of a portfolio that comprises plural securities, the computer program product further comprising instructions to:
cause a device to render a visual representation of the mapping for the plural securities where the visual representation comprises indicia plotted by trader type, and size of indicia representing an aggregate of securities in the portfolio according to trader types of securities.

29. A system comprises:
a processor;
memory; and
a computer readable storage device storing a computer program product, the computer program product including instructions to cause a processor to:
map a time series F(d) of a security or a portfolio of securities to a specific distribution of trader types;
simulate a market to generate a simulated time series M(d) of securities for each possible combination of trader types;
compute a complexity distance between F(d) and every M(d);
select the M(d) with the lowest distance; and
map the security time series F(d) to the point in a representation that is associated with the selected M(d).

30. The system of claim 29 further comprising instructions to:
acquire a time series price(t), to be mapped (e.g. intraday prices, or daily prices) for a security.

31. The system of claim 30 further comprising instructions to:
generate a time series of the absolute value of price changes d(t)=abs(price(t)−price(t−1)).

32. The system of claim 31 further comprising instructions to:
generate an empirical distribution function of the time series F(d) which is the number of price changes that are less than d.

33. The system of claim 32 further comprising instructions to:
normalize the distribution to provide the values of d to lie between a range of values and the values of F(d) to lie between a range of values.

34. The system of claim 29 further comprising instructions to:
produce a simulated time series by:
select an initial price;
sort the simulated traders randomly, and
cause each simulated trader to buy or sell according to the simulated trader's behavior.

35. The system of claim 34 wherein random simulated traders use an unbiased random number generator to decide whether to buy or sell, value simulated traders buy if the price is below the value and sell if it is above the value and momentum simulated traders use a random number generator biased by the previous buys and sells.

36. The system of claim 34 wherein for each simulated buy, the program increases the price by an increment and each time a sell the program decreases the price by the same increment.

37. The system of claim 29 further comprising instructions to:
cause a device to render a representation of the distribution of trader types associated with the security.

38. The system of claim 29 further comprising instructions to:
cause a device to render a visual representation of the mapping where the visual representation is a plot of a distribution of trader types as indices of the visual representation.

39. The system of claim 29 further comprising instructions to:
cause a device to render a visual representation of the mapping where the visual representation is an indicia that represents a set of trader types as indices of the visual representation.

40. The system of claim 39 wherein the indicia represents an individual security.

41. The system of claim 29 wherein the mapping is of a portfolio that comprises plural securities, the computer program product further comprising instructions to:
cause a device to render a visual representation of the mapping for the plural securities where the visual representation comprises indicia plotted by trader type, and each indicia representing an individual security and the size of the indicia in the representation corresponding to an aggregate amount of a value that the security represented by the dot has in the portfolio.

42. The system of claim 29 wherein the mapping is of a portfolio that comprises plural securities, the computer program product further comprising instructions to:
cause a device to render a visual representation of the mapping for the plural securities where the visual representation comprises indicia plotted by trader type, and size of indicia representing an aggregate of securities in the portfolio according to trader types of securities.
